(19) United States
(12) Patent Application Publication
(10) Pub. No.: US 2004/0000239 A1
(43) Pub. Date: Jan. 1, 2004

(54) Method and apparatus for roasting small quantities of coffee beans

(76) Inventor: Harald Munk, Eilsdorf (DE)

Correspondence Address: Thomas M. Freiburger, P.O. Box 1026, Tiburan, CA, 94920, US

(21) Appl. No.: 10/608,931

(22) Filed: Jun. 27, 2003

(30) Foreign Application Priority Data
Jun. 28, 2002 (DE) 102 29 269.8

(51) Int. Cl. A23B 4/00

(52) U.S. Cl. 99/483; 99/470

(57) ABSTRACT

The invention concerns a method and an apparatus for the roasting of small quantities of coffee beans in a vertically aligned, cylindrical roasting chamber, to which unroasted coffee beans can be charged batchwise, and from which, following the roasting procedure, the said coffee beans can be removed. The roasting is effected by means of hot air flow through the roasting chamber (4) and the roasted coffee beans are cooled by a cooling air flow, following their removal from said roast chamber. In accord with the invention, the roasting and the cooling of the coffee beans can be regulated by means of a programmable control element, wherein at least the combination of the parameters, time of roasting, roasting temperature, and volume flow of the roasting hot air are stored as data sets in the control element and the hot air flow can be regulated by means of a frequency speed control of a side channel compressor.

### DESCRIPTION

The invention concerns a method and an apparatus for the roasting of small quantities of coffee beans in accord with the principal concept of the claims 1 and 5.

For the preparation of a particularly aromatic, fresh coffee, the procedure is well known of roasting the coffee beans immediately before the grinding of the beans and the subsequent brewing. This method avoids the volatilization of aromatic substances during a lengthy storage. It is also well known to store ground coffee in vacuum packages over a considerable period of time, although this type of storage likewise has an impact on the aroma.

Thus it is desirable to make use of coffee in its freshest possible roasted state.

Coffee bean roasters are known, which are applicable within a household. However, given the usual household conditions, it is difficult to be certain that such parameters as are appropriate for proper roasting are actually observed.

There is, however, a qualitatively higher stage in roasting equipment, which can economically appear in retail trade, and wherein the lapse in time between the roasting process and personal consumption can be held very short. A coffee bean roaster for such service has been disclosed by EP 0 288 870 B1. In the case of this apparatus, a cylindrical roasting chamber is employed, into which hot air is conducted in such a manner that it induces a turbulent bed therein. This procedure leads to a uniform roasting of the coffee beans. A few minutes after the roasting, the cooled coffee beans can be ground and produce upon brewing a particularly fresh and aromatic coffee drink. For the operating and the control of the process parameters of this equipment, extensive training of an operating person is required, in order to achieve professional results. Direct operating of the equipment by a customer is not possible.

U.S. Pat. No. 6,053,093 teaches a coffee bean roaster with a programmable control device, by means of which the parameters “time of roasting” and “roast temperature” are stored in the controller as optionally adjustable data sets.

However, the input of no more than items of time of roasting and of roasting temperature will yield no optimal roasting results.

The purpose of the invention is to make available a method and an apparatus for the roasting of small quantities of coffee beans with a coffee bean roaster, especially of the kind described in the foregoing, wherein the operating work is minimized, and roast results of high quality can be achieved.

This object is accomplished by the invention as stated in the claims 1 and 5. Advantageous developments of the invention are to be found in the subordinate claims.

The invention bases itself on a method for the roasting of small quantities of coffee beans in a vertically aligned cylindrical roasting chamber, which can be batchwise charged with unroasted coffee beans. Following the roasting process, the roasted beans can then be withdrawn from the chamber. The roasting is accomplished by means of hot air flowing through the roasting chamber. After the withdrawal of the roasted beans, these can be cooled by the through passage of cold air. The roasting and the cooling of coffee beans can be done by means of a programmable control unit, whereby at least the combination of the parameters—namely, roasting time, roasting temperature and flow volume—of the roasting heating air is stored as an optional, selectable data set in the control unit and the hot air flow is controllable by means of a frequency controlled side channel compressor.

By the choice of a predetermined data set at the control unit, it is thus possible for an operating person to achieve roast results of high quality, dependent on the desired roaster characteristics or the quality of the available coffee beans. This does not require special knowledge of matters of machine technology nor familiarity with other parameters which influence the roast results of the coffee beans to be roasted.

A coffee roaster operated by the method in accord with the invention can be run by a person who is not a trained specialist, so that it to be possible that the customer personally can place the coffee roaster in operation and provide the necessary attendance. In this case, recourse to specialized personnel would be necessary only for maintenance and cleaning purposes. In this way the manipulative costs of a coffee roaster of this type are substantially reduced.

The parameters of the applicable data sets are preferably adjustable specifically per program and can be made to match a primary or even a later adaption of the coffee bean roaster to the currently available sorts of coffee beans and their quantity. The program can also be made to fit the characteristics of the individual coffee roaster.

The basic roasting parameters define, advantageously, additionally the parameters of volume flow of the cooling air and the duration of cooling, so that even the cooling of the roasted coffee is individually adjustable.

As further parameters of the data sets, additions can include the color of the roast, i.e., the degree of darkness of the coffee bean, the batch size, the exhaust air temperature and, if necessary, further parameters which contribute to the results of the roasting.

The parameters which affect the roasting can be time-dependently determined in their respective limits, so that the parameters can be made dependent upon one another or can be made to fit ongoing changes in the course of the roasting.

Since the hot air flow is controlled for the roasting of the coffee bean by means of the speed of revolution control of a side channel compressor, the noise generation of the coffee bean roaster can be substantially reduced, since only for a small interval is the full volume flow required for hot air.

The volume flow for creating turbulence in the roasting bed as well as heating the roasting chamber, with the above stated advantages, can advantageously be made to fit the continuing progress of the roasting.

The frequency speed control, beyond this, can compensate for large voltage fluctuations in the supply current.

The invention will be more fully explained with the aid of drawings. There is shown in:

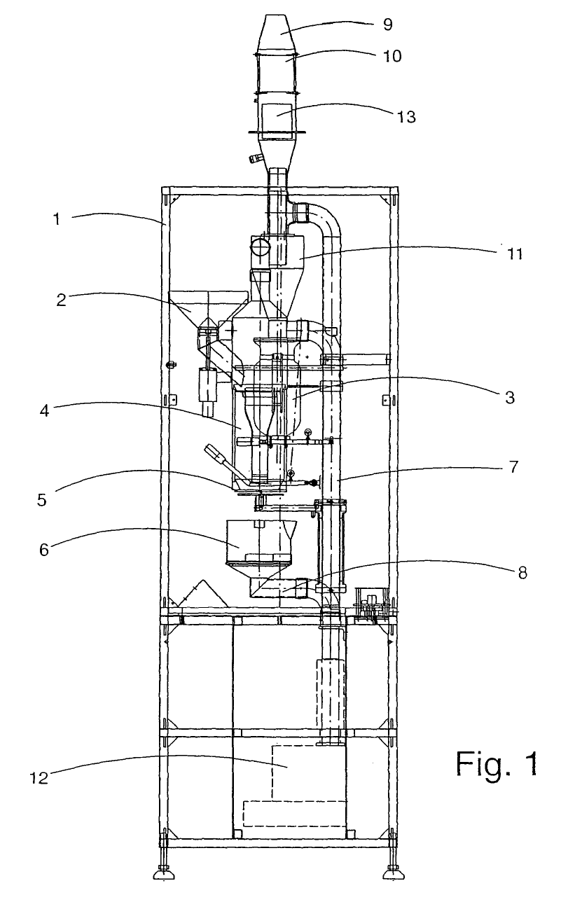

FIG. 1. A profile view of a coffee bean roaster, and

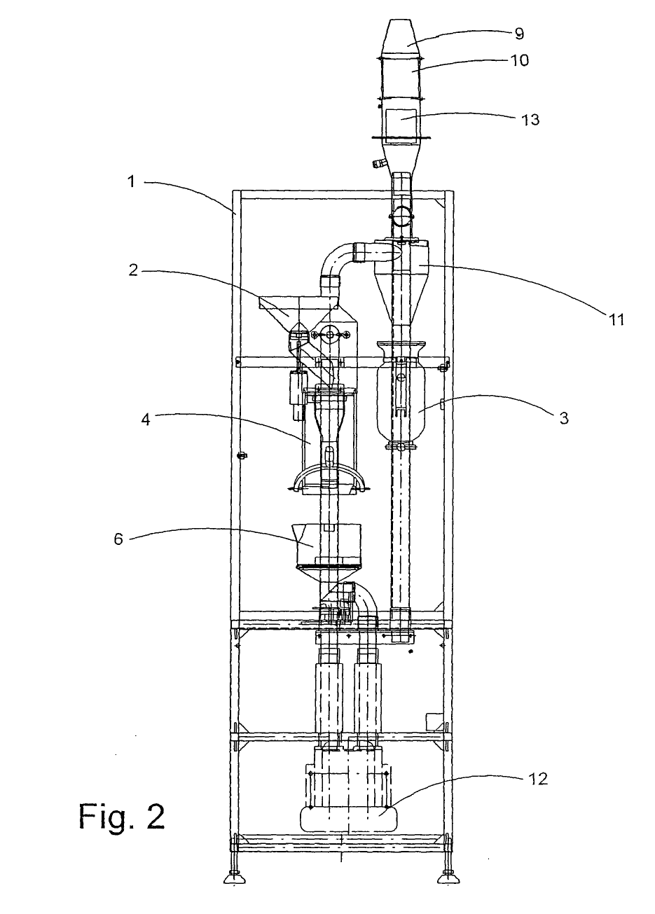

FIG. 2. A front view of a coffee bean roaster.

By the use of the invention, it is possible to operate a fully automatic coffee roasting machine. Principally, only the batch feeding of green, non-roasted beans, as well as the removal of the properly roasted coffee beans is carried out manually.

In accord with the invention, the steps of the method relative to heating, roasting and the cooling in all automatic roasting systems are program-controlled. In the roaster is found advantageously, a memory-programmable control such as used in other industrial equipment. This control permits a plurality of program memory sites to be made available. These program memory sites contain advantageously the following adjustable roasting parameters:

time of roasting

temperature of roasting (which is adjustable during the time of roasting)

volume flow of the roasting hot air (which is adjustable during the time of roasting)

Since the raw coffee quantity and individual characteristics of the coffee determine the energy consumption of a roast, the roasting parameters of the program memory sites have to match the charge which is to be roasted. Even raw coffee beans different roast ratings can be roasted by the correction of the energy inputs within a program, that is to say, by the selection of another program with a different energy input.

For the carrying out of roasting, all of the above named parameters are not necessary in every case. Insofar as it is desired, additional parameters can be applied which can have effect on the control of the roast procedure or the operation of the coffee bean roaster. These parameters might be the volume flow of the cooling air, the time elapse of cooling, the color of the coffee beans, the degree of darkness thereof, the size of the batch or the exhaust air temperature. The process parameters can present set-point values or thresholds and can be adjusted to varying running times. For instance, the coffee beans which are not yet roasted, may at the beginning, hold a content of relatively high roasting moisture, which could be responsible for a difficult intermix in the roasting chamber. To meet this state of affairs, either the start temperature of the roasting machine can be set at a very high level, or the volume flow of the roasting air can be chosen to be correspondingly increased.

The parameters can be employed to adjust or regulate the corresponding equipment on the electrical circuit, namely the heating or the blower. In order to achieve an excellent degree of control, at appropriate positions sensors are provided in the coffee bean roaster which determines the regulating values for the setting of the process parameters.

The coffee bean roaster in FIG. 1 includes a housing 1, which is designed especially as a framework with glass walls so that the customer is enabled to see the machine. At the same time the housing diminishes the operating noise of the machine. The basic construction of a coffee bean roaster of the kind here depicted can be acquired from EP 0 288 870.

By means of an optionally pivotable feeding hopper 2, a predetermined batch of coffee beans can be loaded into the machine. The coffee beans in this step fall into the cylindrical, transparent roasting chamber 4, in which the beans are to be roasted in a bed made turbulent by the inflow of a central hot air stream conducted through a duct 7 connected thereto. At the end of the roasting procedure, by means of a flap type, pivoting bottom closure which is activated by pneumatic, hydraulic or electrical means, the beans are dropped into receiving container 6. By means of a cold air duct 8 communicating with the said receiving container, a cold air flow is established therein in order to effect the cooling of the roasted beans.

The bean skins and husks of the beans are separated out of an exhaust air flow in a cyclone 11 and collected in a receiving tank 3. The air flow leaving the cyclone II enters an outlet section with an afterburner and catalyst device 10, and a heating cartridge 13 for afterburning of exhaust gases after which the exhaust gas is discharged to the atmosphere through a stack 9.

The emptying of the roasting chamber 4 can be done by programmed control. If the feed hopper and/or the receiving container are designed to be pivotable, the pivoting can also be program controlled. On this account, for the fully automatic operation of the roasting procedure, it is only necessary to manually charge a predetermined batch of coffee beans in the feed hopper 2 and at the end of the roasting procedure, again manually remove the roasted beans from the receiving container 6.

The receiving container 6 can also be so designed that following the optional pivoting out of the housing 1, a bag can be clamped onto the underside of the receiving container 6 so that the roasted coffee beans are immediately transferred into the said bag.

FIG. 2 presents the coffee bean roaster of FIG. 1 in a front view. Besides the already demonstrated elements of the coffee roaster, FIG. 2 especially shows in addition the blower 12, which is made as a side channel compressor. This produces the air flow for the roasting of the coffee via connecting duct 7 and also provides the suction air flow via duct 8 for the cooling of the beans. By changing the frequency of the compressor, the quantity of air can be increased or diminished. This change by means of the air flow velocity, affects the roasting procedure and the intermixing of the beans and at the same time governs, in part, the noise emission of the machine. Thereby it becomes possible, following the start of the roast phase and therewith the drying of the originally green beans, to reduce the quantity of air which in turn reduces the noise emission. Shortly before the end of the roasting period, another reduction of the quantity of air is required since the weight loss of the coffee beans is so great that the smaller beans can become entrained in the flow of air.

On this account, the operational frequency of the side channel compressor can be reduced to a very small level so that the noise emission is at a very low level.

Simultaneously with the reduction of the frequency of the side channel compressor, it is also possible to stepwise reduce the roasting temperature.

Upon the filling of the roasting chamber with coffee beans, the emptying of the roasted coffee beans and the emptying of the husk container, the side channel compressor is completely shut down. This can be automatically carried out by appropriate switching elements upon the activation of the respective containers. By this convenience, the advantage is gained that butterfly air valves, other valves or sliding shut-offs can be dispensed with. Furthermore, cleaning and maintenance work is considerably simplified and lessened by this shutdown action.

By means of the invention, a completely, fully automatic coffee bean roaster for small quantities is made available which is especially adaptable for retail business. The program-technological determination of the roasting parameters allows for the choice of specific combinations of the method. For example, certain coffee bean kinds require the choice of defined parameter combinations. That is, for coffee beans from a source A, upon the touch of a button, the choice of a circuit stage 1 is necessary. For the operation of the machine on this account, for instance, 1000 g raw coffee is put into the feed hopper and after the choice, as above, of the circuit stage 1, a START button is pressed. The roasting then runs automatically in accord with the program choice. After the completion of the roasting procedure, the roasted coffee can then be removed from the optionally outward pivoting receiving container (cooling container).

If it occurs that a stored program designated for a definite coffee source results in a less than optimum roasting result, then at the programming level of the equipment, the parameters of a parameter combination can easily be altered. The corresponding technology for such programming is universally known.

Reference Numbers and Associated Components

1 Housing

2 Feed hopper

3 Receiving container for 11

4 Cylindrical roasting chamber

5 Pivoting chamber bottom flap

6 Cooling container, Receives roast beans from chamber

7 Duct-roasting air

8 Duct-cooling air

9 Chimney

10 Catalyst & after burner element

11 Cyclone

12 Side channel compressor

13 Heating cartridge

Claimed is:

1. A method for the roasting of small quantities of coffee beans in a vertically aligned, cylindrical roasting chamber (4), to which unroasted coffee beans can be batchwise charged and from which chamber, following the roasting procedure, the said coffee beans can be removed, wherein the roasting is effected by means of a hot air stream flowing through the chamber and upon the removal of the coffee beans from the said chamber, the beans are cooled by a cooling air flow, characterized in that the roasting and the cooling of the coffee beans is controllable by a programmable control unit, whereby at least the combination of the parameters roasting time, roasting temperature and volume flow of the roasting hot air can be stored in the control unit as selectable data sets with adjustable parameters, whereby the hot air flow is regulated by means of a frequency controlled side channel compressor.

2. A method in accord with claim 1, characterized in that the data sets contain additionally parameters for volume flow of the cooling air and the time of cooling.

3. A method in accord with claim 1 or 2, therein characterized, in that the data sets contain additionally parameters for color, degree of darkness of the coffee beans, quantity of batch feed, and/or exhaust temperature.

4. A method in accord with one of the foregoing claims, characterized by means of the time related variation of the operational parameters and/or the threshold parameters of the data sets.

5. An apparatus for the roasting of small quantities of coffee beans in a vertically aligned, cylindrical roasting chamber (4), to which unroasted coffee beans can be batchwise charged and from which chamber, following the roasting procedure, the said coffee beans can be removed, wherein the roasting is effected by means of a hot air stream flowing through the chamber and upon the removal of the coffee beans from the said chamber, the beans are cooled by a cold air flow, characterized in that the roasting and the cooling of the coffee beans is controllable by a programmable control unit, whereby at least the combination of the parameters roasting time, roasting temperature and volume flow of the roasting hot air can be stored in the control unit as selectable data sets with adjustable parameters, whereby the hot air flow is regulated by means of a frequency controlled side channel compressor.

6. An apparatus in accord with claim 5, characterized in that the data sets contain additionally the parameter of volume flow of the cooling air and time of cooling.

7. An apparatus in accord with claim 5 or 6 characterized in that the data sets contain parameters for: color, degree of darkness of the coffee beans, quantity of batch feed and/or exhaust gas temperature.
